(19) United States
(12) Patent Application Publication
(10) Pub. No.: US 2022/0204829 A1
(43) Pub. Date: Jun. 30, 2022

(54) LIQUID DISPERSION WITH ENHANCED THERMAL CONDUCTIVITY CONTAINING INORGANIC PARTICLES

(71) Applicant: EVONIK OPERATIONS GMBH, Essen (DE)

(72) Inventors: Li-Chung LIU, Taichung City (TW); Paul BRANDL, Taipei (TW)

(73) Assignee: EVONIK OPERATIONS GMBH, Essen (DE)

(21) Appl. No.: 17/605,538

(22) PCT Filed: Apr. 23, 2020
(86) PCT No.: PCT/EP2020/061300

§ 371 Date: Oct. 21, 2021

(30) Foreign Application Priority Data
Apr. 24, 2019 (EP) 19170752.0

(51) Int. Cl. C09K 5/10; C10M 169/04

(52) U.S. Cl. CPC C09K 5/10; C10M 169/04; C10M 2201/061; C10N 2020/02; C10M 2201/065; C10M 2211/0206; C10M 2211/0425; C10M 2201/062

(57) ABSTRACT

The invention relates to liquid dispersion containing surface treated inorganic particle selected from the group consisting of Al₂O₃, AlN, Si₃N₄, SiC, WS₂ and mixtures thereof and at least one liquid fluorinated compound, manufacturing process thereof, and use of such dispersion for increasing thermal conductivity of oil lubricants or heat transfer fluids.

The invention relates to liquid dispersion containing inorganic particle and liquid fluorinated compound, a process for preparation thereof and the use of such dispersion for increasing thermal conductivity of oil lubricants or heat transfer fluids.

Hydrocarbon and silicone fluids, e.g., oils, can provide electrical isolation between a stator and rotor and also power leads in an electric motor. Additionally, oils provide lubrication for engines and motors to extend lifetime and prevent failure. Motor oils lubricate surfaces in relative motion and close contact to one another, such as for example, bearings and other metal surfaces, to improve motor efficiency and motor run life. Additionally, oils can be useful for carrying away heat that is generated within the motor, thereby reducing the operating temperature.

Even for electrical devices without moving parts, heat transfer from static components and their electrical isolation are important issues, particularly in high voltage or high current applications. Additional equipment is sometimes needed to aid the cooling of these devices. New materials for electrical insulation and thermal conduction having suitable viscosities are required.

One possible way to increase thermal conductivity of organic mixtures like oils is to add highly thermally conductive particles such as AlN, BN or others to such mixtures.

CN 102924924 A discloses a paste heat-conductive silicone grease, containing 100 parts of methyl silicon oil and 400-1000 parts of thermally conductive filler treated with 40-200 parts of a coupling agent. The thermally conductive filler may be selected from alumina, AlN, BN, SiC and other materials. The coupling agent is preferably a silane like HMDS or methyl trimethoxysilane. The paste described in CN 102924924 A possesses very high viscosity.

CN108440968A discloses heat-conductive mixtures comprising 5-30 parts of e.g. aluminium nitride (AlN) particles surface treated with a silane, 100-150 parts of vinyl-terminated dimethyl silicone oil, 20-60 parts of a hydrogen-based silicon oil.

Liquid low molecular weight polymers of haloolefins, particularly those containing a high proportion of fluorine are known to be flame resistant and to have superior chemical and thermal stability in contrast to hydrocarbon oils. Therefore, fluorine-based lubricants are widely used for lubrication of various kinds of machineries such as automobiles, electric equipment, construction machines, industrial machines and the parts constituting these machines. Thus, U.S. Pat. No. 2,975,220 describes liquid low molecular weight polymers prepared by polymerization of vinylidene fluoride, suitable as lubricants, hydraulic fluids and the like.

WO 0175955 discloses cleaning compositions based on non-flammable and chemically and thermally stable fluorinated hydrocarbon or ether solvents.

L. Zeininger et al. describe in Chemistry Open 2018, 7, 282-287 preparation of nanoparticles of TiO₂ and Fe₃O₄ surface treated with amides or esters having fluorinated hydrocarbon substituents and dispersions of such surface treated particles in perfluoro(methylcyclohexane). No other than TiO₂ or Fe₃O₄ inorganic particles are described in this paper. Additionally, this paper does not relate to any increase of thermal conductivity of such dispersions or their use as lubricants or in thermal management.

GB2557759 discloses that various surface untreated inorganic nanoparticles, such as boron carbide, boron nitride, graphite, silicon, aluminium nitride, silicon carbide, aluminium oxide, silicon dioxide etc. can be dispersed in base fluids to improve heat transfer properties of these base fluid, such as fluorinated ones (HFE 7000).

US2010187469 discloses heat transfer compositions comprising liquid fluorinated ether and surface untreated metal oxide particles such as Al₂O₃.

A. A. M. Redhwan et al. in international communications in heat and mass transfer, Pergamon, N.Y., vol. 76 (2016), pages 285-293, discloses dispersions of surface untreated nanoparticles, such as Al₂O₃ in hydrofluorocarbon (HFC) and hydrochlorofluorocarbon (HCFC) refrigerants.

Thus, many surface untreated inorganic particles can be used for improving heat transfer properties of fluorinated fluids. However, the compatibility of such particles with the fluid is often limited. As a result, the inorganic particles often tend to agglomerate, leading to larger particles and undesired increased viscosity of the fluid or even precipitation of such particles.

The problem addressed by the present invention is that of providing chemically and thermally stable liquid systems with good heat transferring properties suitable for use in oil lubricants and heat transfer fluids, e.g. for car battery systems. Such systems should be capable of establishing a homogeneous temperature profile in these fluids. Particularly, the invention relates to the problem of providing chemically and thermally stable, preferably inflammable liquid systems with a relatively low viscosity, containing relatively high content of high thermal conductive fillers, thereby the term “stable” refers to the adversity of such systems to e.g. precipitation or viscosity increase during the use or storage of such systems. To achieve such relatively low viscosity, thermal conductive fillers should be fine dispersed, i.e. have relatively small average particle size.

The invention provides liquid dispersion containing inorganic particle selected from the group consisting of Al₂O₃ , AlN, Si₃N₄, SiC, WS₂, and mixtures thereof and at least one liquid fluorinated compound, wherein the inorganic particle is surface treated with a surface treatment agent selected from the group consisting of organosilanes, silazanes, acyclic or cyclic polysiloxanes and mixtures thereof.

An indispensable part of the present invention is the presence of a liquid fluorinated compound.

Liquid Fluorinated Compound

The term “fluorinated compound” in the context of the present invention refers to an organic compound, which contains at least one fluorine atom.

Fluorinated compound referred to in the present invention are liquid at 25° C. and 1 atm. Such liquid fluorinated compound may include hydrofluoroethers (HFEs), hydrofluorocarbons (HFCs), hydrohalofluoroethers (HHFEs) and hydrochlorofluorocarbons (HCFCs) and mixtures thereof.

The liquid fluorinated compounds preferably comprise nonionic, partially fluorinated hydrocarbons that may be linear, branched, or cyclic, and optionally may contain one or more additional catenary heteroatoms, such as nitrogen or oxygen.

The liquid fluorinated compound may be selected from the group consisting of partially-fluorinated alkanes, amines, ethers, and aromatic compounds. The liquid fluorinated compound is preferably nonfunctional, i.e. lacking functional groups that are polymerizable, reactive toward acids, bases, oxidizing agents, reducing agents or nucleophiles.

Preferably, the number of fluorine atoms in the liquid fluorinated compound exceeds the number of hydrogen atoms in this compound.

The liquid fluorinated compound referred to in this invention is preferably non-flammable, which is defined herein as having a flash point of greater than about 60° C. when tested according to ASTM D3278-89.

To be non-flammable, the relationship between the number of fluorine, hydrogen, and carbon atoms can preferably be related in that the number of fluorine atoms is equal to or exceeds the sum of the numbers of hydrogen atoms and carbon-carbon bonds:

number of F atoms≥number of H atoms+number of C—C bonds

It is preferred that the liquid fluorinated compound is partially or incompletely fluorinated, i.e. contains at least one aliphatic or aromatic hydrogen atom in the molecule. Such compounds generally are thermally and chemically stable. The liquid fluorinated compound used in the present invention typically contains from 3 to 20 carbon atoms and may optionally contain one or more catenary heteroatoms, such as divalent oxygen or trivalent nitrogen atoms. Useful liquid fluorinated compounds include cyclic and non-cyclic fluorinated alkanes, amines, ethers, and any mixture thereof.

Preferably, the number of fluorine atoms is equal to or exceeds the sum of the number of combined hydrogen atoms and carbon-carbon bonds. The fluorinated compound optionally may contain one or more chlorine atoms.

One class of liquid fluorinated compounds suitable for the liquid dispersion of the present invention is hydrofluorocarbons (HFCs), i.e. compounds having only carbon, hydrogen and fluorine, and optionally catenary divalent oxygen and/or trivalent nitrogen. Such compounds are nonionic, may be linear or branched, cyclic or acyclic. Such compounds are of the formula CₙHₘF₂ₙ₊₂₋ₘ (I), where n is from about 3 to 20 inclusive, m is from 1 to 41, and where one or more non-adjacent-CF₂-groups may be replaced with catenary oxygen or trivalent nitrogen atoms. Preferably the number of fluorine atoms is equal to or greater than the number of hydrogen atoms, and more preferably the number of fluorine atoms is equal to or exceeds the sum of the combined number of hydrogen atoms and carbon-carbon bonds of fluorine atoms.

Preferably used are hydrofluorocarbons having a 3- to 16-carbon backbone. The carbon backbone can be linear, branched, cyclic, or a combination of these. Useful HFCs include compounds having more than approximately 5 molar percent fluorine substitution, or less than about 95 molar percent fluorine substitution, based on the total number of hydrogen and fluorine atoms bonded to carbon, but having essentially no substitution with other atoms (e.g., chlorine). Useful HFCs can be selected from compounds of the following general formula: CₙHₘF₂ₙ₊₂₋ₘ (I),

wherein n is at least 3, and m is at least one. Representative compounds of this type include CF₃CH₂CF₂H, CF₂HCF₂CH₂F, CH₂FCF₂CFH₂, CF₂HCH₂CF₂H, CF₂HCFHCF₂H, CF₃CFHCF₃, CF₃CH₂CF₃, CHF₂(CF₂)₂CF₂H, CF₃CF₂CH₂CH₂F, CF₃CH₂CF₂CH₂F, CH₃CHFCF₂CF₃, CF₃CH₂CH₂CF₃, CH₂FCF₂CF₂CH₂F, CF₃CH₂CF₂CH₃, CHF₂CH(CF₃)CF₃, CHF(CF₃)CF₂CF₃, CF₃CH₂CHFCF₂CF₃, CF₃CHFCH₂CF₂CF₃ CF₃CH₂CF₂CH₂CF₃, CF₃CHFCHFCF₂CF₃, CF₃CH₂CH₂CF₂CF₃, CH₃CHFCF₂CF₂CF₃, CF₃CF₂CF₂CH₂CH₃, CH₃CF₂CF₂CF₂CF₃, CF₃CH₂CHFCH₂CF₃, CH₂FCF₂CF₂CF₂CF₃, CHF₂CF₂CF₂CF₂CF₃, CH₃CF(CHFCHF₂)CF₃, CH₃CH(CF₂CF₃)CF₃, CHF₂CH(CHF₂)CF₂CF₃, CHF₂CF(CHF₂)CF₂CF₃, CHF₂CF₂CF(CF₃)₂, CHF₂(CF₂)₄CF₂H, (CF₃CH₂)₂CHCF₃, CH₃CHFCF₂CHFCHFCF₃, HCF₂CHFCF₂CF₂CHFCF₂H, H₂CFCF₂CF₂CF₂CF₂CF₂H, CHF₂CF₂CF₂CF₂CF₂CHF₂, CH₃CF(CF₂H)CHFCHFCF₃, CH₃CF(CF₃)CHFCHFCF₃, CH₃CF(CF₃)CF₂CF₂CF₃, CHF₂CF₂CH(CF₃)CF₂CF₃, CHF₂CF₂CF(CF₃)CF₂CF₃, CH₃CHFCH₂CF₂CHFCF₂CF₃, CH₃(CF₂)₅CH₃, CH₃CH₂(CF₂)₄CF₃, CF₃CH₂CH₂(CF₂)₃CF₃, CH₂FCF₂CHF(CF₂)₃CF₃, CF₃CF₂CF₂CHFCHFCF₂CF₃, CF₃CF₂CF₂CHFCF₂CF₂CF₃, CH₃CH(CF₃)CF₂CF₂CF₂CH₃, CH₃CF(CF₃)CH₂CFHCF₂CF₃, CH₃CF(CF₂CF₃)CHFCF₂CF₃, CH₃CH₂CH(CF₃)CF₂CF₂CF₃, CHF₂CF(CF₃)(CF₂)₃CH₂F, CH₃CF₂C(CF₃)₂CF₂CH₃, CHF₂CF(CF₃)(CF₂)₃CF₃; CH₃CH₂CH₂CH₂CF₂CF₂CF₂CF₃, CH₃(CF₂)₆CH₃, CHF₂CF(CF₃)(CF₂)₄CHF₂, CHF₂CF(CF₃)(CF₂)₄CHF₂, CH₃CH₂CH(CF₃)CF₂CF₂CF₂CF₃, CH₃CF(CF₂CF₃)CHFCF₂CF₂CF₃, CH₃CH₂CH₂CHFC(CF₃)₂CF₃, CH₃C(CF₃)₂CF₂CF₂CF₂CH₃, CH₃CH₂CH₂CF(CF₃)CF(C F₃)₂ and CH₂FCF₂CF₂CHF(CF₂)₃CF₃.

A preferred class of liquid fluorinated compounds particularly useful to form the liquid dispersion of the invention comprises hydrofluoroethers (HFEs) of the general formula 2 (R¹—O)ₖ—R² (II) where, in reference to Formula (II), k is a number from 1 to 10, preferably from 1 to 3, R¹ and R² are the same or are different from one another and are selected from the group consisting of alkyl, aryl, and alkylaryl groups and their derivatives. At least one of R¹ and R² contains at least one fluorine atom, and preferably at least one of R¹ and R² contains at least one hydrogen atom. R¹ and R² may be linear, branched, cyclic or acyclic and optionally, one or both of R¹ and R² may contain one or more catenary heteroatoms, such as trivalent nitrogen or divalent oxygen. Preferably the number of fluorine atoms is equal to or greater than the number of hydrogen atoms, and more preferably the number of fluorine atoms is equal to or exceeds the sum of the number of combined numbers of hydrogen atoms and carbon-carbon bonds. R¹ or R² or both optionally may contain one or more chlorine atoms. The examples of such hydrofluoroethers include HCF₂OCF₂OCF₂H, HCF₂OCF₂CF₂OCF₂H, HC₃F₆OCH₃, HCF₂OCF₂OC₂F₄OCF₂H, and mixtures thereof.

More preferably, the liquid dispersion of the present invention contains fluorinated compound of the formula R³—O—R⁴ (III) wherein, R³ and R⁴ are selected from the group consisting of alkyl, aryl, and alkylaryl groups and their derivatives, wherein R³ contains at least one fluorine atom, and R⁴ may contain no fluorine atoms. More preferably, R⁴ is an acyclic branched or straight chain alkyl group, such as methyl, ethyl, n-propyl, iso-propyl, n-butyl, i-butyl, or t-butyl, and R³ is preferably a fluorinated derivative of a cyclic or acyclic, branched or straight chain alkyl group having from 3 to about 14 carbon atoms, such as n-C₃F₇, i-C₃F₇, n-C₄F₉, n-C₆F₁₃, cyclo-C₆F₁₁, n-C₇F₁₅, n-C₈F₁₇. R³ may optionally contain one or more catenary heteroatoms, such as trivalent nitrogen or divalent oxygen atoms. Most preferably, R¹ and R², or R³ and R⁴, are chosen so that the fluorinated compound has at least three carbon atoms, and the total number of hydrogen atoms in the compound is at most equal to the number of fluorine atoms. Still more preferably, R¹ and R² or R³ and R⁴ are chosen so that the fluorinated compound has at least three carbon atoms, and the number of fluorine atoms is equal to or exceeds the sum of the number of combined hydrogen atoms and carbon-carbon bonds.

Particularly preferred liquid fluorinated compounds of formula (III) include n-C₃F₇OCH₃, (CF₃)₂CFOCH₃, n-C₄F₉OCH₃, (CF₃)₂CFCF₂OCH₃, n-C₃F₇₀C₂H₅, n-C₄F₉OC₂H₅, (CF₃)₂CFCF₂₀C₂H₅, (CF₃)₃COCH₃, (CF₃)₃COC₂H₅, n-C₅F₁₁OC₂H₅, n-C₅F₁₁OCH₃, n-C₆F₁₃OC₂H₅, n-C₆F₁₃OCH₃, n-C₇F₁₅OC₂H₅, n-C₇F₁₅OCH₃, n-C₈F₁₇OC₂H₅, n-C₈F₁₇OCH₃, and mixtures thereof.

Both R³ and R⁴ substituents in liquid fluorinated compounds of formula (Ill) may also contain fluorine atoms. The examples of such hydrofluoroethers include C₄F₉OC₂F₄H, C₆F₁₃OCF₂H, HC₃F₆OC₃F₆H, C₃F₇OCH₂F, and mixtures thereof.

Useful liquid fluorinated compounds also include hydrohalofluoroethers (HHFEs). For the present invention, HHFEs are defined as ether compounds containing fluorine, non fluorine halogen (i. e., chlorine, bromine, and/or iodine) and hydrogen atoms. An important subclass of HHFEs is perfluoroalkylhaloethers (PFAHEs). PFAHEs are defined as ether compounds having a perfluoroalkyl group and a haloalkyl group having carbon-bonded hydrogen atoms and halogen atoms, wherein at least one of the halogen atoms is chlorine, bromine, or iodine. Useful PFAHEs include those described by the general structure shown in Formula (IV) : R_{f}—O—CₐH_{b}F_{c}X_{d} (IV) wherein R_{f} is a perfluoroalkyl group preferably having at least about 3 carbon atoms, most preferably from 3 to 10 carbon atoms, and optionally containing a catenary heteroatom such as nitrogen or oxygen; X is a halogen atom selected from the group consisting of bromine, iodine, and chlorine; “a” preferably is from about 1 to 10 ;“b” is at least 1 ;“c” can range from 0 to about 2 ;“d” is at least 1 ; and b+c+d is equal to 2a+1. Such PFAHEs are described in PCT Publication No. WO 99/14175. Useful PFAHEs include c-C₆F₁₁OCH₂Cl, (CF₃)₂CFOCHCl₂, (CF₃)₂CFOCH₂Cl, CF₃CF₂CF₂OCH₂Cl, CF₃CF₂CF₂OCHCl₂, (CF₃)₂CFCF₂OCHCl₂, (CF₃)₂CFCF₂OCH₂Cl, CF₃CF₂CF₂CF₂OCHCl₂, CF₃CF₂CF₂CF₂OCH₂Cl, (CF₃)₂CFCF₂OCHCICH₃, CF₃CF₂CF₂CF₂OCHCICH₃, (CF₃)₂CFCF(C₂F₅)OCH₂C₁, (CF₃)₂CFCF₂OCH₂Br, and CF₃CF₂CF₂OCH₂I

Useful fluorinated solvents also include hydrochlorofluorocarbons (HCFCs). For the present invention, HCFCs are defined as compounds containing a carbon backbone substituted with carbon-bound fluorine, chlorine, and hydrogen atoms. HCFCs useful in the present invention include CF₃CHCl₂, CH₃CCl₂F, CF₃CF₂CHCl₂ and CClF₂CF₂CHClF.

The liquid fluorinated compound used in the liquid dispersion of the present invention preferably has a molecular weight of up to 1000 g/mol, more preferably up to 800 g/mol, even more preferably up to 500 g/mol.

The liquid fluorinated compound suitable for the liquid dispersion according to the present invention preferably has a dynamic viscosity measured at a shear rate of 10 s⁻¹ and 25° C. of less than 2000 mPa*s, more preferably of less than 1000 mPa*s, even more preferably of less than 1000 mPa*s.

Inorganic Particle

Inorganic particle contained in the liquid dispersion of the present invention is selected from the group consisting of aluminium oxide (Al₂O₃), aluminium nitride (AlN), silicon nitride (Si₃N₄), silicon carbide (SiC), tungsten disulphide (WS₂), and mixtures thereof.

In the case of Al₂O₃, it is preferable when the corresponding fumed metal oxide particles, i.e. the metal oxide particles obtained from pyrogenic processes, are employed. In such processes, metal compounds are reacted in a flame generated by the reaction of hydrogen and oxygen. The thus obtained powders are referred to as “pyrogenic” or “fumed” metal oxides. The reaction initially forms highly disperse primary particles, which in the further course of reaction coalesce to form aggregates. The aggregate dimensions of these powders are generally in the range of 0.2-1 μm. Said powders may be partially destructed and converted into the nanometre (nm) range particles advantageous for the present invention by suitable grinding.

It is also possible to employ other types of metal oxides, such as precipitated metal oxides or metal oxide sols, for example precipitated silica, precipitated alumina, precipitated titanium dioxide, silica sol, alumina sol or titanium dioxide sol.

AlN can be synthesized by the carbothermal reduction of aluminium oxide in the presence of gaseous nitrogen or ammonia or by direct nitridation of aluminium.

Silicon nitride (Si₃N₄) can be prepared by heating powdered silicon between 1300° C. and 1400° C. in a nitrogen environment, from silicon tetrachloride and ammonia by a diimide method or by carbothermal reduction of silicon dioxide in nitrogen atmosphere at 1400-1450° C.

Silicon carbide (SiC) can be manufactured by thermal treatment of sand (SiO₂) in the presence of carbon at high temperature.

WS₂ can be produced by several synthetic methods involving treating tungsten oxides with sources of sulfide or hydrosulfide, directly supplied in this form or generated in situ. Other routes entail thermolysis of tungsten(VI) sulphides e.g., (R₄N)₂WS₄) or WS₃.

The inorganic particle preferably has a number median particle diameter d₅₀ of less than 10 μm, more preferably less than 2 μm, more preferably 20 nm-1 μm, even more preferably 50 nm-800 nm, still more preferably 100 nm-700 nm. The number median particle diameter can be determined by dynamic light scattering method (DLS) directly in dispersion according to the present invention. The inorganic particles may be in the form of isolated individual particles and/or in the form of aggregated particles. In the case of aggregated particles, the number median particle diameter refers to the size of the aggregates.

Surface Treatment Agent

The inorganic particle present in the liquid dispersion according to the invention is surface treated. This surface treatment, particularly a hydrophobic surface treatment may improve the compatibility of inorganic particles with hydrophobic liquid fluorinated compounds.

Surface treated inorganic particles used in liquid dispersion of the present invention can be obtained by surface treatment of the corresponding untreated inorganic particles with surface treatment agents.

The inorganic particle is surface treated with a surface treatment agent selected from the group consisting of organosilanes, silazanes, acyclic or cyclic polysiloxanes and mixtures thereof.

One type of preferred organosilanes is an alkyl organosilane of the general formula R′ₓ(RO)_{y}Si(CₙH₂ₙ₊₁) (Va) and R′ₓ(RO)_{y}Si(CₙH₂ₙ₋₁) (Vb)

wherein

R=alkyl, such as, for example, methyl-, ethyl-, n-propyl-, i-propyl-, butyl-.

R′=alkyl or cycloalkyl, such as, for example, methyl, ethyl, n-propyl, i-propyl, butyl, cyclohexyl, octyl, hexadecyl.

n=1-20

x+y=3

x=0-2, and

y=1-3.

Among alkyl organosilanes, particularly preferred are octyltrimethoxysilane, octyltriethoxysilane, hexadecyltrimethoxysilane, hexadecyltriethoxysilane.

Organosilanes used for surface treatment may contain halogens such as Cl or Br. Particularly preferred are the halogenated organosilanes of the following types:
organosilanes of the general formula X₃Si(CₙH₂ₙ₊₁) (VIa) and X₃Si(CₙH₂ₙ₋₁) (VIb), wherein X=Cl, Br, n=1-20;
organosilanes of the general formula X₂(R′)Si(CₙH₂ₙ₊₁)(VIIa) and X₂(R′)Si(CₙH₂ₙ₋₁) (VIIb), wherein X=Cl, Br

R′=alkyl, such as, for example, methyl, ethyl, n-propyl, i-propyl, butyl, cycloalkyl such as cyclohexyl

n=1-20;
organosilanes of the general formula X(R′)₂Si(CₙH₂ₙ₊₁) (VIIIa) and X(R′)₂Si(CₙH₂ₙ₋₁) (VIIIb),

wherein X=Cl, Br

R′=alkyl, such as, for example, methyl, ethyl, n-propyl, i-propyl, butyl, cycloalkyl such as cyclohexyl

n=1-20

Among halogenated organosilanes, particularly preferred is dimethyldichlorosilane.

The used organosilanes can also contain other than alkyl or halogen substituents, e.g. fluorine or some functional groups. Preferably used are functionalized organosilanes of the general formula (R″)ₓ(RO)_{y}Si(CH₂)ₘR′ (IX),

wherein

R″=alkyl, such as methyl, ethyl, propyl, or halogen such as Cl or Br,

R=alkyl, such as methyl, ethyl, propyl,

x+y=3

x=0-2,

y=1-3

m=1-20,

R′=methyl-, aryl (for example, phenyl or substituted phenyl residues), heteroaryl —C₄F₆, OCF₂—CHF—CF₃, —C₆F₁₃, —O—CF₂—CHF₂, —NH₂, —N₃, —SCN, —CH═CH₂, —NH—CH₂—CH₂—NH₂, —N—(CH₂—CH₂—NH₂)₂—OOC(CH₃)C═CH₂, —OCH₂—CH(O)CH₂, —NH—CO—N—CO—(CH₂)₅—NH—COO—CH₃, —NH—CO—CH₂—CH₃, —NH—(CH₂)₃Si(OR)₃, —Sₓ—(CH₂)₃Si(OR)₃, —SH, —NR¹R²R³ (R¹=alkyl, aryl; R²=H, alkyl, aryl; R³=H, alkyl, aryl, benzyl, C₂H₄NR⁴R⁵ with R⁴=H, alkyl and R⁵=H, alkyl).

Among functionalized organosilanes, particularly preferred are 3-methacryloxypropyltrimethoxysilane, 3-methacryloxypropyltriethoxysilane, glycidyloxypropyltrimethoxysilane, glycidyloxypropyltriethoxysilane, aminopropyltriethoxysilane.

Particularly preferably, the surface treatment agent used for preparation of surface treated inorganic particles present in the liquid dispersion of the present invention is an organosilane containing fluorine atoms. The examples of such fluorinated organosilanes are nonafluorohexyltrimethoxysilane [(CH₃O)₃SiC₆H₄F₉], tridecafluorooctyltrimethoxysilane [(CH₃O)3SiC₈H₄F₁₃], tridecafluorooctyltriethoxysilane [(C₂H₅O)₃SiC₈H₄F₁₃].

Silazanes of the general formula R′R₂Si—NH—SiR₂R′ (X), wherein R=alkyl, such as methyl, ethyl, propyl; R′=alkyl, vinyl, are suitable as a surface treatment agent. The most preferred silazane is hexamethyldisilazane (HMDS).

Also suitable as surface treatment agents are cyclic polysiloxanes, such as octamethylcyclotetrasiloxane (D4), decamethylcyclopentasiloxane (D5), dodecamethylcyclohexasiloxane (D6), hexamethylcyclotrisiloxane (D6). Most preferably among cyclic polysiloxanes, D4 is used.

Another useful type of surface treatment agents is polysiloxanes or silicone oils of the general formula (XI):

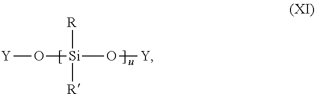

wherein

Y=H, CH₃, CₙH₂ₙ₊₁, wherein n=1-20, Si(CH₃)ₐX_{b}, wherein a=2-3, b=0 or 1, a+b=3,

X=H, OH, OCH₃, CₘH₂ₘ₊₁, wherein m=1-20.

R, R′=alkyl, such as CₒH₂₀₊₁, wherein o=1 to 20, aryl, such as phenyl and substituted phenyl residues, heteroaryl, (CH₂)ₖ—NH₂, wherein k=1-10, H,

u=2-1000, preferably u=3-100.

Most preferably among polysiloxanes and silicone oils, polydimethylsiloxanes are used as surface treatment agents for preparation of liquid dispersions according to the present invention. Such polydimethylsiloxanes usually have a molar mass of 162 to 7500 g/mol, a density of 0.76 to 1.07 g/ml and viscosities of 0.6 to 1 000 000 mPa*s.

Liquid Dispersion

The term “liquid” in the context of the present invention refers to a state of matter, which is liquid at 25° C. and pressure of 1 atm.

The liquid dispersion of the present invention preferably contains 1% to 30%, more preferably 2% to 25%, even more preferably 5% to 20% by weight of the inorganic particle and 70% to 99%, more preferably 75% to 98%, even more preferably 80% to 95% by weight of the liquid fluorinated compound.

The liquid dispersion according to the present invention may comprise other than inorganic particles and liquid fluorinated compounds.

The liquid dispersion according to the invention can contain any types of lubricant base oils, mineral, synthetic or natural, animal or vegetable oils suited for use as constituents of this liquid dispersion. The base oils used in liquid dispersion of the present invention include, for example, conventional base stocks selected from API (American Petroleum Institute) base stock categories known as Group I, Group II, Group III, Group IV and Group V. The Group I and II base stocks are mineral oil materials (such as paraffinic and naphthenic oils) having a viscosity index (or VI) of less than 120. Group I is further differentiated from Group II in that the latter contains greater than 90% saturated materials and the former contains less than 90% saturated material (that is more than 10% unsaturated material). Group III is considered the highest level of mineral base oil with a VI of greater than or equal to 120 and a saturates level greater than or equal to 90%. Preferably the base oil included in the liquid dispersion of the present invention is selected from the group consisting of API Group II and III base oils. Most preferably, the lubricant composition comprises an API Group III base oil. Group IV base oils are polyalphaolefins (PAO). Group V base oils are esters and any other base oils not included in Group I to IV base oils. These base oils can be used individually or as a mixture.

The liquid dispersion according to the present invention may comprise organic solvents. Possible organic solvents include hydrocarbon solvents, for example aromatic solvents such as toluene, benzene and xylene, saturated hydrocarbons, for example cyclohexane, heptane, octane, nonane, decane, dodecane, which may be present in linear or branched form. These solvents may be used individually and as a mixture.

The liquid dispersion of the present invention may also comprise any type of additives suitable for use in the formulations. These additives include viscosity index improvers (like PAMA, OCP, PIB), pour point depressants, dispersants (like succinimides), demulsifiers, defoamers, anti-wear additives (like ZDDPs, phosphates, dithiophosphates, dithiocabamates), extreme pressure additives (like sulphurized i-butenes, di-i-butens fatty acid esters, or thiadiazoles), lubricity additives, friction modifiers (like alkyldimethylphosphonates, glycerinmono-oleate, bis(2-hydroxyethyl)alkyllamines, phenolic or aminic antioxidants, detergents (like sulfonates, phenates), dyes, corrosion inhibitors (like succinic partial ester), yellow metal deactivator (like triazoles) and/or odourants.

The liquid dispersion according to the present invention preferably possess a relatively low viscosity. Thus, dynamic viscosity of the liquid dispersion of the invention measured at a shear rate of 10 s⁻¹ and 25° C., is preferably less than 10 000 mPa*s, more preferably less than 5 000 mPa*s, most preferably less than 1 000 mPa*s, particularly preferably less than 500 mPa*s. Dynamic viscosity can be measured with a viscometer or rheometer.

The presence of thermally conductive inorganic particles in the liquid dispersion of the present invention leads to increased thermal conductivity of this dispersion. Therefore, the liquid dispersion of the present invention typically has a relatively high thermal conductivity, when compared with its liquid components, including the liquid fluorinated compound. Thus, thermal conductivity of the liquid dispersion is preferably at least 20%, more preferably, at least 30%, even more preferably 40%, still more preferably 50% larger than thermal conductivity of the liquid fluorinated compound or the mixture of such compounds present in the dispersion.

Thermal conductivity of the liquid dispersion according to the present invention is preferably at least 0.06 W/m*K, more preferably at least 0.07 W/m*K, even more preferably at least 0.08 W/m*K, still even more preferably at least 0.09 W/m*K.

Thermal diffusion of the liquid dispersion of the present invention is preferably at least 0.04 mm²/sec, more preferably at least 0.05 mm²/sec, even more preferably at least 0.06 mm²/sec, still more preferably from 0.06 mm²/sec to 0.12 mm²/sec.

Specific heat of the liquid dispersion of the present invention is preferably less than 2.0 MJ/(m³*K), more preferably less than 1.9 MJ/(m³*K), even more preferably less than 1.8 MJ/(m³*K), still more preferably less than 1.7 MJ/(m³*K), most preferably from 1.0 MJ/(m³*K) to 1.7 MJ/(m³*K),

Thermal conductivity, thermal diffusion and specific heat of the liquid dispersion of the present invention can be measured at ambient temperature, e.g. 23° C. by a hot disc method using a hot disc thermal analyser, such as TPS 3500 (manufacturer Hot Disc AB).

The process for obtaining the liquid dispersion

The invention provides process for producing the liquid dispersion of the present invention, comprising the following steps:

(i) providing an inorganic particle selected from the group consisting of Al₂O₃, AlN, Si₃N₄, SiC, WS₂, and mixtures thereof surface treated with a surface treatment agent selected from the group consisting of organosilanes, silazanes, acyclic or cyclic polysiloxanes and mixtures thereof;

(ii) mixing the inorganic particle with at least one liquid fluorinated compound;

(iii) optional milling of the resulting dispersion prepared in step (ii) using a high shear energy milling device.

Step (i) of the inventive process is preferably carried out by treating of surface untreated inorganic particle selected from the group consisting of Al₂O₃, AlN, Si₃N₄, SiC, WS₂, and mixtures thereof with a surface treatment agent selected from the group consisting of organosilanes, silazanes, acyclic or cyclic polysiloxanes and mixtures thereof.

In this step (i), the untreated inorganic particle is preferably sprayed with a surface treatment agent selected from the group consisting of organosilanes, silazanes, acyclic or cyclic polysiloxanes and mixtures thereof, at ambient temperature (about 25° C.) and the mixture is subsequently treated thermally at a temperature of 50° C. to 400° C. over a period of 1 to 6 hours.

An alternative method for surface treatment of the inorganic particle in step (i) can be carried out by treating the inorganic particle with a surface treatment agent in vapour form and subsequently treating the mixture thermally at a temperature of 50° C. to 800° C. over a period of 0.5 to 6 hours.

The thermal treatment can be conducted under protective gas, such as, for example, nitrogen. The surface treatment can be carried out in heatable mixers and dryers with spraying devices, either continuously or batchwise. Suitable devices can be, for example, ploughshare mixers or plate, cyclone, or fluidized bed dryers.

The amount of surface treatment agent used strongly depend on the kind of the inorganic particle and of the surface treatment agent applied. However, usually from 1% to 15%, preferably 2% -10% by weight of the surface treatment agent related to the amount of the inorganic particles, is employed.

Mixing the inorganic particle with at least one fluorinated hydrocarbon in step (ii) of the process according to the invention can be carried out using any suitable mixing device, such as a dissolver. Preferably, the mixture of the inorganic particles and the liquid fluorinated compound is stirred at a rotating speed of at least 10 rotations per minute (rpm), more preferably at a speed of at least 100 rpm. Preferably, step (ii) is carried out at ambient temperature, e.g. 25° C.

In optional step (iii) of the inventive process, the resulting dispersion prepared in step (ii) of the process is milled using a high shear energy milling device.

High shear milling device used in the process according to the invention can supply enough energy to provide inventive dispersions with a number mean particle size d₅₀ of less than 5 μm, more preferably with d₅₀ of less than 1 μm, more preferably with d₅₀ of less than 800 nm. During this milling process, the larger particles such as agglomerates or aggregates may be broken to smaller particles resulting in overall decrease in particle size. Preferably, the milling device operating with the dispersion will supply about 10⁻⁴ cal/cm² or more, more preferably from 10⁻⁴ to 10⁻³ cal/cm² energy while milling.

Such high shear milling device can be selected from planetary and blade-type mixers, homogenizers, rotor-stator machines, media mills, jet mills, wet jet mills. Preferably, step (iii) is carried out using a wet jet mill. In this case, the pressure in the milling chamber is preferably at least 500 bar, more preferably at least 800 bar, even more preferably 1000 bar.

Step (iii) of the inventive process may be unnecessary.

The Use of the Liquid Dispersion

The invention further provides the use of the liquid dispersion according to the invention as a constituent of oil lubricant, such as a transmission fluid, an engine oil, a gear oil, a hydraulic oil, a lubricating grease, heat transfer fluids in battery systems or other electrical equipment.

Particularly, the invention provides the use of the liquid dispersion of the invention for increasing thermal conductivity of oil lubricants and/or heat transfer fluids.

The liquid dispersion of the present invention may be a constituent of a heat transfer fluid, especially for electrical equipment. Such heat transfer fluids, particularly cooling liquids should have a high specific heat capacity and should in particular be suitable for use in thermal management systems for high power batteries. The inventive dispersion may be used in heat transfer fluid for electrical equipment like electric batteries, electric motors, electric transformers, electric power converters, electric capacitors, fluid-filled transmission lines, fluid-filled power cables, and computers. The examples of such heat transfer fluids are given in patent applications WO 2013115925 A1 and WO 2014106556 A1.

Experimental Part

Measurement Methods

Thermal Conductivity, Thermal Diffusion, Specific Heat

Thermal conductivity, thermal diffusion and specific heat were measured at 23° C. by hot disk method, using a hot disc thermal analyser TPS 3500 (manufacturer Hot Disc AB) with a measurement sensor of type 7577.

Viscosity

Dynamic viscosity was measured with a rheometer MCR 301 (manufacturer: Anton Paar).

Particle Size

The average particle size d₅₀ of inorganic particles was measured by dynamic light scattering method using Zetasizer device (manufacturer: Malvern Panalytical).

Preparation of Surface Treated Al₂O₃

A 50 wt % solution of tridecafluorooctyl triethoxysilane (Dynasylan® F8261, manufacturer: Evonik Resource Efficiency GmbH) in isopropyl alcohol was sprayed at ambient temperature (23° C.) on untreated AEROXIDE® Alu 65 (hydrophilic fumed Al₂O₃, BET=ca. 65 m²/g, manufacturer: Evonik Resource Efficiency GmbH) in powder form using a spraying device. The amount of the used silane was 3 wt %, related to the amount of Al₂O₃ powder used. Surface treated Al₂O₃ was dried at 60° C. in an air circulation oven for 3 hours and used for preparation of dispersions without any further treatment.

Preparation of Surface Treated AlN

A 50 wt % solution of tridecafluorooctyl triethoxysilane (Dynasylan® F8261, manufacturer: Evonik Resource Efficiency GmbH) in isopropyl alcohol was sprayed at ambient temperature (23° C.) on untreated aluminium nitride (AlN, average particle size: 80 nm) in powder form using a spraying device. The amount of the used silane was 3 wt %, related to the amount of AlN powder used. Surface treated AlN was dried at 60° C. in an air circulation oven for 3 hours and used for preparation of dispersions without any further treatment.

Preparation of Liquid Dispersions

Dispersion 1 (Comparative Example)

Surface untreated AlN powder was mixed with hydrofluorether C₇F₁₅OC₂H₅ (Novec™ 7500, manufacturer: 3M) while stirring using DISPERMAT® dissolver (manufacturer: VMA-Getzmann GmbH). The amount of AlN was 5 wt %, related to the amount of the fluorinated liquid used. The mixed liquid was then milled in a wet jet mill JN20 (manufacturer: JOKOH) at 1200 bar pressure in milling chamber. After milling, the liquid dispersion can be diluted without any phase changes. The dispersion was stable upon storage at 25° C. for at least several weeks. After dispersion, particle size distribution, viscosity and thermal conductivity were measured, the results are summarized in Table 1.

Dispersion 2 (Inventive)

The prepared surface treated AlN powder was mixed with hydrofluorether C₇F₁₅OC₂H₅ (Novec™ 7500, manufacturer: 3M) while stirring using DISPERMAT® dissolver (manufacturer: VMA-Getzmann GmbH). The amount of AlN was 5 wt %, related to the amount of the fluorinated liquid used. The dispersion possessed low viscosity and no further milling was required. The dispersion was stable upon storage at 25° C. for at least several weeks. Particle size distribution, viscosity and thermal conductivity of the resulting dispersion were measured, the results are summarized in Table 1.

Dispersion 3 (Inventive)

The prepared surface treated Al₂O₃ powder was mixed with hydrofluorether C₇F₁₅OC₂H₅ (Novec™ 7500, manufacturer: 3M) while stirring using DISPERMAT® dissolver (manufacturer: VMA-Getzmann GmbH). The amount of surface treated Al₂O₃ was 5 wt %, related to the amount of the fluorinated liquid used. The dispersion possessed low viscosity and no further milling was required. The dispersion was stable upon storage at 25° C. for at least several weeks. Particle size distribution, viscosity and thermal conductivity of the resulting dispersion were measured, the results are summarized in Table 1.

As it can be seen from the Table 1, liquid dispersions 1-3 containing thermally conductive fillers and a fluorinated liquid C₇F₁₅OC₂H₅ show considerably higher thermal conductivities when compared with the pure fluorinated liquid (an increase of more than 50% in all cases). The dynamic viscosity of such dispersions remains relatively low. The use of surface treated inorganic particles (dispersions 2 and 3) allow to improve the compatibility of particles with the fluorinated fluid. Therefore, no high energy milling is required in order to achieve low viscosity dispersions 1 and 2.

TABLE 1

| | | | | Dynamic | | | |
|---|---|---|---|---|---|---|---|
| | | | Thermal | viscosity | Particle | Thermal | Specific |
| Fluid or | Inorganic | Surface | conductivity | at 10 s⁻¹ | size, d₅₀ | diffusion | heat |
| Dispersion | Particle | Treatment | [W/m*K] | [mPa*s] | [μm] | [mm²/sec] | [MJ/(m³*K)] |
| C₇F₁₅OC₂H₅ | No | No | 0.05942 | 1 | — | 0.02753 | 2.158 |
| (pure) | | | | | | | |
| 1 | AlN | No | 0.08956 | 100 | 7.90 | 0.04939 | 1.813 |
| 2 | AlN | Dynasylan ® | 0.09927 | 20 | 0.60 | 0.06098 | 1.628 |
| | | F8261 | | | | | |
| 3 | Al₂O₃ | Dynasylan ® | 0.1023 | 15 | 0.59 | 0.08161 | 1.254 |
| | | F8261 | | | | | |

1-14. (canceled)

15. A liquid dispersion comprising at least one liquid fluorinated compound and inorganic particles selected from the group consisting of: Al₂O₃ , AlN, Si₃N₄, SiC, WS₂and mixtures thereof, wherein the inorganic particles are surface treated with a surface treatment agent selected from the group consisting of: organosilanes; silazanes; acyclic or cyclic polysiloxanes; and mixtures thereof.

16. The liquid dispersion of claim 15, wherein dynamic viscosity of the dispersion measured at a shear rate of 10 s⁻¹ and 25° C., is less than 10 000 mPa*s.

17. The liquid dispersion of claim 15, wherein thermal conductivity of the dispersion is at least 0.06 W/m*K.

18. The liquid dispersion of claim 15, wherein thermal conductivity of the dispersion is at least 20% larger than thermal conductivity of the liquid fluorinated compound or the mixture of such compounds present in the dispersion.

19. The liquid dispersion of claim 15, wherein the dispersion contains 1% to 30% by weight of the inorganic particles and 70% to 99% by weight of the liquid fluorinated compound.

20. The liquid dispersion of claim 15, wherein the surface treatment agent is an organosilane containing fluorine atoms.

21. The liquid dispersion of claim 15, wherein the liquid fluorinated compound is selected from the group consisting of: hydrofluoroethers; hydrofluorocarbons;
hydrohalofluoroethers; hydrochlorofluorocarbons and mixtures thereof.

22. The liquid dispersion of claim 15, wherein the liquid fluorinated compound has a dynamic viscosity measured at a shear rate of 10 s⁻¹ and 25° C. of less than 2000 mPa*s.

23. The liquid dispersion of claim 15, wherein the inorganic particle has a mean particle size d₅₀ of less than 10 μm.

24. The liquid dispersion of claim 15, wherein the liquid dispersion has a thermal diffusion of at least 0.04 mm²/sec and specific heat of less than 2.0 MJ/(m³*K).

25. The liquid dispersion of claim 16, wherein thermal conductivity of the dispersion is at least 20% larger than thermal conductivity of the liquid fluorinated compound or the mixture of such compounds present in the dispersion.

26. The liquid dispersion of claim 25, wherein the dispersion contains 1% to 30% by weight of the inorganic particles and 70% to 99% by weight of the liquid fluorinated compound.

27. The liquid dispersion of claim 26, wherein the surface treatment agent is an organosilane containing fluorine atoms.

28. The liquid dispersion of claim , wherein the liquid fluorinated compound is selected from the group consisting of: hydrofluoroethers; hydrofluorocarbons; hydrohalo-fluoroethers; hydrochlorofluorocarbons and mixtures thereof.

29. The liquid dispersion of claim 16, wherein the inorganic particle has a mean particle size d₅₀ of less than 10 μm.

30. The liquid dispersion of claim 29, wherein the liquid dispersion has a thermal diffusion of at least 0.04 mm²/sec and specific heat of less than 2.0 MJ/(m³*K).

31. A process for producing the liquid dispersion of claim 15, comprising:
(i) providing inorganic particles selected from the group consisting of: Al₂O₃; AlN; Si₃N₄; SiC; WS₂; TiO₂; and mixtures thereof, wherein the particles are surface treated with a surface treatment agent selected from the group consisting of: organosilanes; silazanes; acyclic; cyclic polysiloxanes; and mixtures thereof;
(ii) mixing the inorganic particles with at least one liquid fluorinated compound;
(iii) optionally milling the resulting dispersion prepared in step (ii) using a high shear energy milling device.

32. The process of claim 31, wherein the high shear milling device is selected from the group consisting of: planetary and blade-type mixers; homogenizers; rotor-stator machines; media mills; jet mills; and wet jet mills.

33. An oil lubricant comprising the liquid dispersion of claim 15.

34. The oil lubricant of claim 33, wherein the oil lubricant is a transmission fluid, an engine oil, a gear oil, a hydraulic oil, a lubricating grease, or a heat transfer fluid in battery systems or other electrical equipment.
